(19) United States
(12) Patent Application Publication
(10) Pub. No.: US 2015/0271698 A1
(43) Pub. Date: Sep. 24, 2015

(54) Method, Apparatus, And Computer Program Product For Facilitating Load Based Changes Of Data Offloading Thresholds

(71) Applicant: Nokia Technologies Oy, Espoo (FI)

(72) Inventors: Lars Dalsgaard, Oulu (FI); Jussi-Pekka Koskinen, Oulu (FI); Jorma Kaikkonen, Oulu (FI)

(21) Appl. No.: 14/664,040

(22) Filed: Mar. 20, 2015

Related U.S. Application Data
(60) Provisional application No. 61/968,969, filed on Mar. 21, 2014.

(51) Int. Cl. H04W 28/02; H04L 5/00; H04W 28/08

(52) U.S. Cl. CPC H04W 28/0221; H04W 28/08; H04L 5/0051

(57) ABSTRACT

Methods, apparatuses, and computer program products are provided to facilitate load based changes in data offloading thresholds. In the context of a method, the method includes causing measurement of a reference signal received power of a serving cell in the first network to be performed; causing measurement of a reference signal received quality of a serving cell in the first network to be performed; and causing one or more network metrics for a second network to be acquired. The method further includes determining, by a processor, whether the measured reference signal received quality is lower than a reference signal received quality threshold; determining, by the processor, whether the measured reference signal received power is lower than a reference signal received power threshold; and in the case where the measured reference signal received quality is lower than the reference signal received quality threshold: cause the reference signal received power threshold to be adjusted; determine whether each of the acquired network metrics for the second network meet an associated network metric condition; and if all the associated network metric conditions are met, data offloading can be performed from the first network to the second network; and in the case where the measured reference signal received power is lower than the reference signal received power threshold: cause the reference signal received quality threshold to be adjusted; determine whether each of the acquired network metrics for the second network meet an associated network metric condition; and if all the associated network metric conditions are met, data offloading can be performed from the first network to the second network. A corresponding apparatus and a computer program product are also provided.

### CROSS REFERENCES TO RELATED APPLICATIONS

The present application claims the benefit of U.S. Provisional Application No. 61/968,969, filed Mar. 21, 2014 and titled, “Method, Apparatus, and Computer Program Product for Facilitating Load Based Changes if Data Offloading Thresholds,” the contents of which is hereby incorporated by reference in its entirety.

### TECHNOLOGICAL FIELD

An example embodiment of the present invention relates generally to data offloading in wireless networks, and more particularly, to using various network measurements and thresholds in facilitating changes in data offloading thresholds.

### BACKGROUND

To provide easier and/or faster information transfer and convenience, communication industry service providers are continually developing improvements to existing communication networks. As a result, wireless communication has become increasingly more reliable. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels are utilizing mobile terminals to communicate with other individuals or contacts, receive services and/or share information, media and other content.

Due to such increases in use, service providers increasingly need to manage their networks to handle continuing increases in data traffic. One such solution is provided by mobile data offloading, where data traffic originally intended for delivery over a first network may be offloaded to other available networks. However, a number of deficiencies and problems associated with data offloading have been identified. Through applied effort, ingenuity, and innovation, many of these identified problems have been solved by developing solutions that are included in embodiments of the present invention, some examples of which are described herein.

### BRIEF SUMMARY

A method, apparatus, and computer program product are therefore provided in accordance with an example embodiment to facilitate changes in data offloading thresholds. In this regard, the method, apparatus, and computer program product of an example embodiment may facilitate using various network measurements and thresholds in changing or applying data offloading thresholds, such as reference signal received power (RSRP), reference signal received quality (RSRQ), wireless local area network (WLAN) received channel power indicator (RCPI), WLAN received signal to noise indicator (RSNI), channel utilization in a BSS load element, available downlink and uplink backhaul data rate, and the like.

In one embodiment a method is provided, the method comprising causing measurement of a reference signal received power of a serving cell in the first network to be performed; causing measurement of a reference signal received quality of a serving cell in the first network to be performed; causing one or more network metrics for a second network to be acquired; determining, by a processor, whether the measured reference signal received quality is lower than a reference signal received quality threshold; determining, by the processor, whether the measured reference signal received power is lower than a reference signal received power threshold; and in the case where the measured reference signal received quality is lower than the reference signal received quality threshold: cause the reference signal received power threshold to be adjusted; determine whether each of the acquired network metrics for the second network meet an associated network metric condition; and if all the associated network metric conditions are met, data offloading can be performed from the first network to the second network; and in the case where the measured reference signal received power is lower than the reference signal received power threshold: cause the reference signal received quality threshold to be adjusted; determine whether each of the acquired network metrics for the second network meet an associated network metric condition; and if all the associated network metric conditions are met, data offloading can be performed from the first network to the second network.

In some embodiments, the method may further comprise wherein the network metrics for the second network comprise one or more of: channel utilization, backhaul downlink bandwidth, backhaul uplink bandwidth, and received signal strength indicator.

In some embodiments, the method may further comprise receiving the reference signal received power threshold from the first network; receiving the reference signal received quality threshold from the first network; and receiving one or more network metric thresholds from the first network.

In some embodiments, the method may further comprise wherein causing the reference signal received power threshold to be adjusted comprises one of ignoring the reference signal received power threshold or changing the reference signal received power threshold and causing the reference signal received quality threshold to be adjusted comprises one of ignoring the reference signal received quality threshold or changing the reference signal received quality threshold. In some embodiments, the method may further comprise wherein the second network is a wireless local area network.

In one embodiment a method is provided, the method comprising causing measurement of a reference signal received power of a serving cell in the first network; causing measurement of a reference signal received quality of a serving cell in the first network; causing one or more network metrics for a second network to be acquired; determining, by a processor, whether the measured reference signal received quality is higher than a reference signal received quality threshold; determining, by the processor, whether the measured reference signal received power is higher than a reference signal received power threshold; comparing each of the acquired network metrics for the second network to an associated network metric condition; and in the case where the measured reference signal received quality is higher than the reference signal received quality threshold and the measured reference signal received power is higher than the reference signal received power threshold, data offloading can be performed from the second network to the first network; or in the case where one or more of the acquired network metrics for the second network meets the associated network metric condition, data offloading can be performed from the second network to the first network. In some embodiments, an indication may be provided that data offloading can be performed, for example, to other circuitry controlling the data offloading.

In some embodiments, the method may further comprise wherein the network metrics for the second network comprise one or more of channel utilization, backhaul downlink bandwidth, backhaul uplink bandwidth, and received signal strength indicator.

In some embodiments, the method may further comprise: receiving the reference signal received power threshold from the first network; receiving the reference signal received quality threshold from the first network; and receiving one or more network metric thresholds from the first network.

In some embodiments, the method may further comprise wherein the second network is a wireless local area network.

In one embodiment, an apparatus is provided, the apparatus comprising at least one processor and at least one memory including computer program code, the at least one memory and the computer program code configured to, with the at least one processor, cause the apparatus at least to cause measurement of a reference signal received power of a serving cell in the first network to be performed; cause measurement of a reference signal received quality of a serving cell in the first network to be performed; cause one or more network metrics for a second network to be acquired; determine whether the measured reference signal received quality is lower than a reference signal received quality threshold; determine whether the measured reference signal received power is lower than a reference signal received power threshold; and in the case where the measured reference signal received quality is lower than the reference signal received quality threshold: cause the reference signal received power threshold to be adjusted; determine whether each of the acquired network metrics for the second network meet an associated network metric condition; and if all the associated network metric conditions are met, data offloading can be performed from the first network to the second network; and in the case where the measured reference signal received power is lower than the reference signal received power threshold: cause the reference signal received quality threshold to be adjusted; determine whether each of the acquired network metrics for the second network meet an associated network metric condition; and if all the associated network metric conditions are met, data offloading can be performed from the first network to the second network.

In some embodiments, the apparatus further comprises wherein the network metrics for the second network comprise one or more of: channel utilization, backhaul downlink bandwidth, backhaul uplink bandwidth, and received signal strength indicator.

In some embodiments, the apparatus further comprises the at least one memory and the computer program code configured to, with the at least one processor, cause the apparatus at least to: receive the reference signal received power threshold from the first network; receive the reference signal received quality threshold from the first network; and receive one or more network metric thresholds from the first network.

In some embodiments, the apparatus may further comprise wherein causing the reference signal received power threshold to be adjusted comprises one of ignoring the reference signal received power threshold or changing the reference signal received power threshold and causing the reference signal received quality threshold to be adjusted comprises one of ignoring the reference signal received quality threshold or changing the reference signal received quality threshold. In some embodiments, the apparatus further comprises wherein the second network is a wireless local area network.

In one embodiment, an apparatus is provided, the apparatus comprising at least one processor and at least one memory including computer program code, the at least one memory and the computer program code configured to, with the at least one processor, cause the apparatus at least to cause measurement of a reference signal received power of a serving cell in the first network; cause measurement of a reference signal received quality of a serving cell in the first network; cause one or more network metrics for a second network to be acquired; determine whether the measured reference signal received quality is higher than a reference signal received quality threshold; determine whether the measured reference signal received power is higher than a reference signal received power threshold; compare each of the acquired network metrics for the second network to an associated network metric condition; and in the case where the measured reference signal received quality is higher than the reference signal received quality threshold and the measured reference signal received power is higher than the reference signal received power threshold, data offloading can be performed from the second network to the first network; or in the case where one or more of the acquired network metrics for the second network meets the associated network metric condition, data offloading can be performed from the second network to the first network.

In some embodiments, the apparatus further comprises wherein the network metrics for the second network comprise one or more of channel utilization, backhaul downlink bandwidth, backhaul uplink bandwidth, and received signal strength indicator.

In some embodiments, the apparatus further comprises the at least one memory and the computer program code configured to, with the at least one processor, cause the apparatus at least to: receive the reference signal received power threshold from the first network; receive the reference signal received quality threshold from the first network; and receive one or more network metric thresholds from the first network.

In some embodiments, the apparatus further comprises wherein the second network is a wireless local area network.

In one embodiment, a computer program product is provided comprising at least one non-transitory computer-readable storage medium bearing computer program code portions embodied therein for use with a computer, the computer program code portions comprising program code instructions configured, upon execution, to: cause measurement of a reference signal received power of a serving cell in the first network to be performed; cause measurement of a reference signal received quality of a serving cell in the first network to be performed; cause one or more network metrics for a second network to be acquired; determine whether the measured reference signal received quality is lower than a reference signal received quality threshold; determine whether the measured reference signal received power is lower than a reference signal received power threshold; and in the case where the measured reference signal received quality is lower than the reference signal received quality threshold: cause the reference signal received power threshold to be adjusted; determine whether each of the acquired network metrics for the second network meet an associated network metric condition; and if all the associated network metric conditions are met, data offloading can be performed from the first network to the second network; and in the case where the measured reference signal received power is lower than the reference signal received power threshold: cause the reference signal received quality threshold to be adjusted; determine whether each of the acquired network metrics for the second network meet an associated network metric condition; and if all the associated network metric conditions are met, data offloading can be performed from the first network to the second network.

In some embodiments, the computer program product further comprises wherein the network metrics for the second network comprise one or more of: channel utilization, backhaul downlink bandwidth, backhaul uplink bandwidth, and received signal strength indicator.

In some embodiments, the computer program product further comprises program code instructions configured, upon execution, to: receive the reference signal received power threshold from the first network; receive the reference signal received quality threshold from the first network; and receive one or more network metric thresholds from the first network.

In some embodiments, the computer program product may further comprise wherein causing the reference signal received power threshold to be adjusted comprises one of ignoring the reference signal received power threshold or changing the reference signal received power threshold and causing the reference signal received quality threshold to be adjusted comprises one of ignoring the reference signal received quality threshold or changing the reference signal received quality threshold. In some embodiments, the computer program product further comprises wherein the second network is a wireless local area network.

In one embodiment, a computer program product is provided comprising at least one non-transitory computer-readable storage medium bearing computer program code portions embodied therein for use with a computer, the computer program code portions comprising program code instructions configured, upon execution, to: cause measurement of a reference signal received power of a serving cell in the first network; cause measurement of a reference signal received quality of a serving cell in the first network; cause one or more network metrics for a second network to be acquired; determine whether the measured reference signal received quality is higher than a reference signal received quality threshold; determine whether the measured reference signal received power is higher than a reference signal received power threshold; compare each of the acquired network metrics for the second network to an associated network metric condition; and in the case where the measured reference signal received quality is higher than the reference signal received quality threshold and the measured reference signal received power is higher than the reference signal received power threshold, data offloading can be performed from the second network to the first network; or in the case where one or more of the acquired network metrics for the second network meets the associated network metric condition, data offloading can be performed from the second network to the first network.

In some embodiments, the computer program product further comprises wherein the network metrics for the second network comprise one or more of channel utilization, backhaul downlink bandwidth, backhaul uplink bandwidth, and received signal strength indicator.

In some embodiments, the computer program product further comprises program code instructions configured, upon execution, to: receive the reference signal received power threshold from the first network; receive the reference signal received quality threshold from the first network; and receive one or more network metric thresholds from the first network.

In some embodiments, the computer program product further comprises wherein the second network is a wireless local area network.

Additionally, embodiments of the present invention, such as example embodiments described herein, may provide for the use of measurements of various network metrics and thresholds in addition to, or as an alternative to the use of reference signal received power (RSRP) and reference signal received quality (RSRQ) measurements and thresholds. For example, embodiments may use a variety of network metrics such as metrics which indicate received power of a signal, received quality of a signal, or the like, including wireless local area network received channel power indicator, wireless local area network received signal to noise indicator, channel utilization in a BSS load element, available downlink and uplink backhaul data rate or the like, in place of or in addition to metrics for RSRP and RSRQ as described herein.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 illustrates an example environment in which devices may operate in accordance with an example embodiment of the present invention;

FIG. 2 illustrates a block diagram of an apparatus that may be specifically configured in accordance with an example embodiment of the present invention;

FIG. 3 illustrates an application of RSRQ and RSRP thresholds in data offloading in accordance with an example embodiment of the present invention;

FIG. 4 illustrates an application of RSRQ and RSRP thresholds in data offloading in accordance with an example embodiment of the present invention;

FIG. 5 provides a flow chart illustrating operations for determining data offloading performed by an apparatus in accordance with an example embodiment of the present invention;

FIG. 6 provides a flow chart illustrating operations for determining data offloading performed by an apparatus in accordance with an example embodiment of the present invention;

FIG. 7 provides a flow chart illustrating operations for determining data offloading performed by an apparatus in accordance with an example embodiment of the present invention;

FIG. 8 provides a flow chart illustrating operations for determining data offloading performed by an apparatus in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

A method, apparatus, and computer program product are therefore provided in accordance with an example embodiment to facilitate changes in data offloading thresholds. In this regard, the method, apparatus, and computer program product of an example embodiment may facilitate using reference signal received power (RSRP) and reference signal received quality (RSRQ) measurements in changing or applying data offloading thresholds.

A solution for managing increasing network traffic is provided by mobile data offloading, where data traffic originally intended for delivery over cellular networks may be offloaded to other available networks or to other available cells of the cellular network. One proposal for enabling smart and efficient offloading of data from a cellular network, such as a 3GPP (3^{rd} Generation Partnership Project) based network, to an alternative network, such as a wireless local area network (WLAN), is the use of reference signal received power (RSRP) based offloading thresholds. For example, for a mobile device camped in a cellular network, such as an evolved universal terrestrial radio access network (E-UTRAN), the mobile device may be configured with a RSRP based offloading threshold from the network and may measure the RSRP in the serving cell. The mobile device may then perform offloading, such as to an available WLAN or another available cell, when or if the measured serving cell RSRP crosses the configured RSRP threshold. Otherwise, while the measured serving cell RSRP remains above the configured RSRP threshold, the mobile device will not perform offloading.

Based on the network choice of the RSRP offloading threshold, the offloading may cover different levels of cell edge situations. With this approach, if the network would like to change the offloading threshold based on experienced load, the network would need to change the configured RSRP offloading threshold for all the mobile devices when the load changes.

As cell edge mobile devices may also be influenced by interference from other cells, it may be challenging to decide on an RSRP based threshold as this measurement only informs about a downlink (DL) cell-specific reference signal (CRS) level and does not include load information. By introducing the use of other measurements and thresholds, such as reference signal received quality (RSRQ) measurements, in an example embodiment of the present invention, the load and interference also become part of the offloading decision.

For example, if only an RSRP offloading threshold is used and is set so that under certain conditions users at the cell edge would be offloaded, changes in load and interference are not taken into account. For example, strong inter-cell interference could be present but this information would not be used effectively in the offloading decision. In a similar manner, the use of only an RSRP offloading threshold also hinders efficient offloading of users experiencing high RSRP values even if such users would experience very high interference or load, for example, offloading of mobile devices close to the base station might be very difficult.

An example embodiment of the present invention enables load and interference to be taken into account, such as by using RSRQ measurements, in offloading decisions when using offloading thresholds, such as RSRP based offloading thresholds.

Additionally, embodiments of the present invention, such as the example embodiments described herein, may provide for the use of measurements of various network metrics and thresholds in addition to or as an alternative to the use RSRP and RSRQ measurements and thresholds. For example, embodiments may use a variety of network metrics such as metrics which indicate received power of a signal, received quality of a signal, or the like, including a wireless local area network received channel power indicator (e.g., received signal strength indicator), wireless local area network received signal to noise indicator, channel utilization in a BSS load element, available downlink and uplink backhaul data rate (e.g., backhaul downlink bandwidth, backhaul uplink bandwidth), or the like, in place of or in addition to measurements and thresholds for RSRP and RSRQ as described herein.

For example, in some embodiments, offloading may be performed if RSRP thresholds or RSRQ thresholds are met and if thresholds for metrics of the alternate network, such as a WLAN, are also met based on which thresholds have been configured in the UE. For example, a UE may first determine that a RSRP measurement is below a low threshold or a RSRQ measurement is below a low threshold and then make a determination whether the WLAN thresholds configured in the UE have been met before determining that data traffic should be offloaded from the cellular network to the WLAN network. The configured WLAN thresholds may comprise one or more of WLAN channel utilization, WLAN downlink bandwidth, WLAN uplink bandwidth, WLAN beacon received signal strength indicator, or the like.

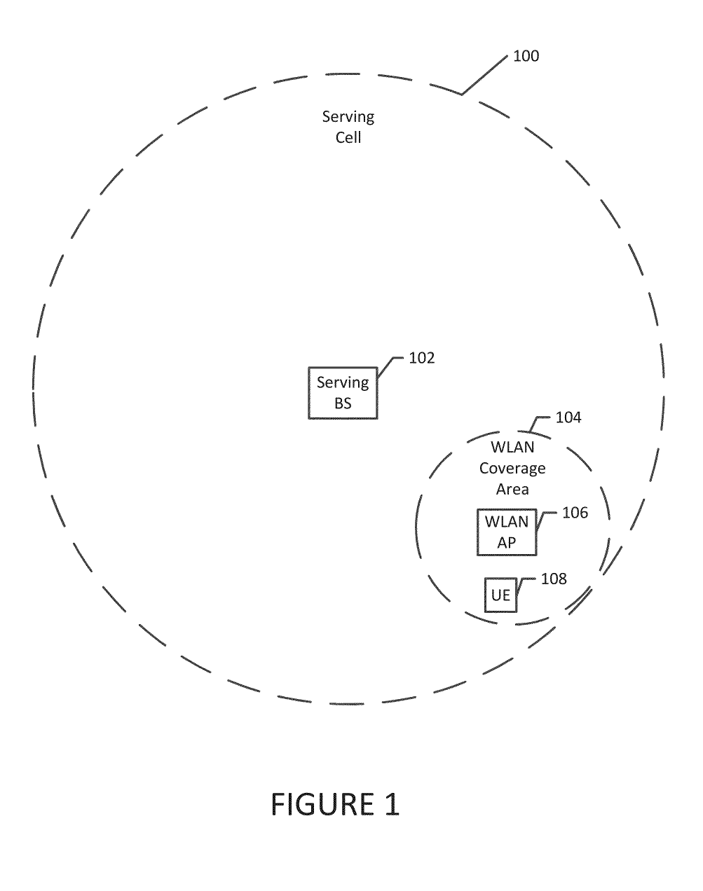

FIG. 1 illustrates an example of an environment in which a plurality of devices may operate in accordance with an example embodiment. As illustrated in the embodiment of FIG. 1, an example environment may comprise multiple networks which may be configured to support a plurality of communication devices. The multiple networks of the environment may be configured to support the transmission and receipt of communications between the networks and the plurality of devices, such communication may comprise voice and/or data communications.

As illustrated in the embodiment of FIG. 1, the environment may include one or more cells for a cellular network which may provide communications from/to one or more devices, such as serving cell 100. When a cell of a network is providing communications from/to (serving) a communication device, it may be referred to as the serving cell. In some embodiments, the cellular network may be embodied as one of a universal terrestrial radio access network (UTRAN), an evolved universal terrestrial radio access network (E-UTRAN), a Global System for Mobile communications (GSM) based network, a Code Division Multiple Access (CDMA) based network, and the like, and may support communications using Long Term Evolution (LTE) standards, Universal Mobile Telecommunications (UTMS) standards, or the like. The cells of the cellular network may be supported by base station radios (BS), such as serving BS 102. While the embodiment illustrated in FIG. 1 only shows a single cell, serving cell 100, of a network, other embodiments may comprise networks made up of multiple cells and may provide for offloading of data between cells of the same network or to overlapping cells of multiple networks.

The environment illustrated in the embodiment of FIG. 1 may also include one or more other networks, such as a WiFi network like wireless local area network (WLAN) 104, HotSpot 2.0 (HS2.0) capable networks, and the like, supported by one or more access points (AP), such as WLAN AP 106. The serving cell 100 and the WLAN 104 may support communications to/from one or more devices, such as user equipment 108, that are within range of the serving cell or WLAN.

The environment illustrated in the embodiment of FIG. 1 may also include one or more devices, such as user equipment (UE) 108, which provide users with communication services and may be configured to provide for transmission of voice and/or data communications over both a cellular network, such as serving cell 100 or another cell of the network, and an alternative network, such as WLAN 104.

An example embodiment of the present invention may facilitate mobile data offloading wherein data originally intended to be transmitted over a cellular network, such as using serving cell 100, may be offloaded to a complementary network, such as a WiFi network like WLAN 104 for example, for transmission to/from UE 108. Alternatively or additionally, in some embodiments, mobile data offloading may be facilitated between cells of a cellular network or between cells of multiple cellular networks, such as offloading data from the current serving cell to another overlapping cell. In some embodiments, the data may be offloaded from a first network, such as a WiFi network like WLAN 104, to a cell of a cellular network, such as cell 100. An example embodiment may facilitate making load based changes in data offloading thresholds to enable more efficient and smart offloading from a cellular network to a WiFi network, for example, such as by using reference signal received power (RSRP) and reference signal received quality (RSRQ) measurements in determining data offloading thresholds.

In some embodiments, a UE, such as UE 108, may be configured with one or more thresholds used in making offloading decisions. The UE may determine whether to apply or adjust the offloading threshold, or choose between multiple offloading thresholds, based on the load currently being experienced in the serving cell of the cellular network. For example, the UE may determine whether to apply the reference signal received power (RSRP) based offloading threshold depending on the currently measured load in the serving cell, such as by using reference signal received quality (RSRQ) measurements.

In some embodiments, a UE may be configured with one RSRP offloading threshold and one RSRQ threshold. The RSRP offloading threshold may indicate the RSRP limit where the UE should perform offloading, if possible (e.g., where another network or cell is available to carry the data, such as a WiFi network). Then, while the UE is in the serving cell, the UE may measure the RSRP and RSRQ of the serving cell. While the measured RSRQ of the serving cell does not cross, that is, does not satisfy, the defined RSRQ threshold (e.g., lower load conditions in the serving cell), the UE will apply the RSRP offloading threshold to determine whether offloading should take place. For example, the UE would then compare the measured RSRP of the serving cell to the RSRP threshold, and if the measured RSRP crosses, that is, satisfies, the RSRP threshold, the UE would cause offloading to the other network or cell (for example, the WLAN). If the measured RSRP does not cross the RSRP threshold the UE would not perform data offloading, such as from the cellular network to the WLAN. Alternatively, in some embodiments, the determination that the threshold is satisfied may cause an indication to be provided that data offloading can be performed, for example, to other circuitry controlling the data offloading.

On the other hand, when the measured RSRQ of the serving cell crosses the defined RSRQ threshold (e.g., high load conditions in the serving cell), the UE would not use the RSRP offloading threshold. In this instance, such as when the measured load is high, the UE would cause offloading from the cellular network to the WLAN without considering the RSRP offloading threshold.

In other embodiments, a UE may be configured with one RSRP offloading threshold and one RSRQ threshold and the UE may measure the RSRP and RSRQ of the serving cell. The UE may be configured to adjust the offloading threshold based on the serving cell load, such as measured using RSRQ measurements. For example, when the serving cell load is low (measured RSRQ does not cross the defined RSRQ threshold), the UE would not adjust the offloading threshold and when the serving cell load is high (measured RSRQ crosses the defined RSRQ threshold), the RSRP offloading threshold may be lowered or the UE may use a second RSRP threshold signaled by the network.

In other embodiments, a UE may be configured with multiple RSRQ thresholds and corresponding RSRP offloading thresholds. The UE may then measure the RSRP and RSRQ of the serving cell and determine which RSRP offloading threshold to apply based on which RSRQ thresholds the measured RSRQ of the serving cell has crossed.

An example embodiment of the present invention provides for including load conditions in offloading decisions and provide for considering aspects of interference in offloading decisions. An example embodiment may also provide for offloading of data from UEs that are close to a base station, for example, when the load in the serving cell is high.

In some embodiments, data traffic may be offloaded from a first network, such as a WiFi network like WLAN 104, to a cell of a cellular network, such as cell 100. For example, a UE may be configured with a plurality of thresholds associated with the cellular network and the WLAN and use the plurality of thresholds to determine whether traffic should be moved from the WLAN to a cell in the cellular network. For example, the UE may be configured with one or more of a RSRP high threshold, a RSRQ high threshold, a WLAN channel utilization high threshold, WLAN backhaul downlink low threshold, a WLAN backhaul uplink low threshold, and a WLAN beacon received signal strength indicator low threshold. The UE may then use a combination of these configured thresholds to determine whether to move data traffic from the WLAN to the cellular network. In some embodiments, for example, the UE may determine that offloading from the WLAN to the cell should occur if the RSRP measurement is above a high threshold and the RSRQ measurement is above a high threshold. In another example, the UE may determine that offloading from the WLAN to the cell should occur if any one of the configured WLAN thresholds is met. Alternatively, in some embodiments, the determination that the threshold is satisfied may cause an indication to be provided that data offloading can be performed, for example, to other circuitry controlling the data offloading.

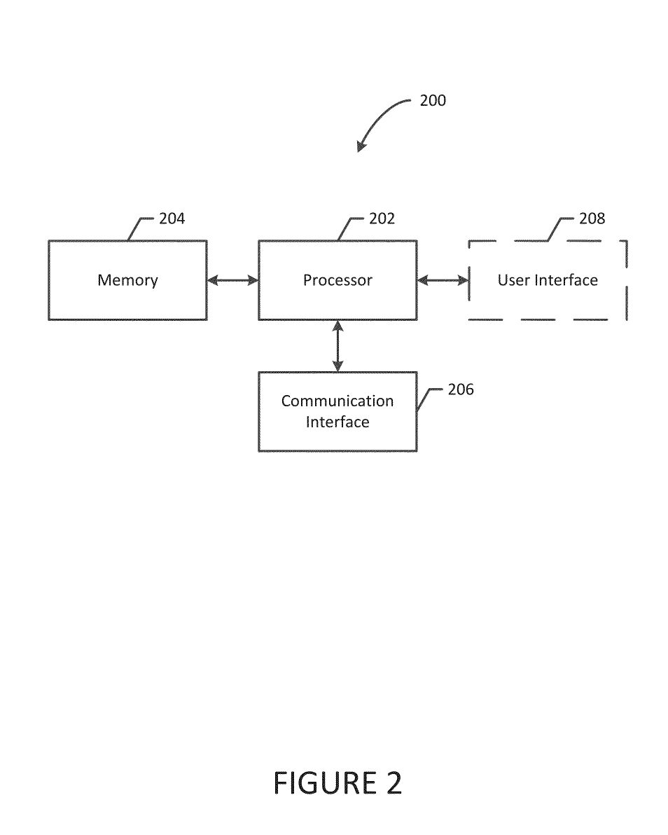

FIG. 2 depicts an apparatus 200 that may be specifically configured in accordance with an example embodiment of the present invention. Such an apparatus may be embodied by or associated with a variety of electronic devices including a mobile terminal, such as a mobile telephone, smartphone, tablet device, laptop computer, smart watch, gaming device, other types of voice and/or data communications systems, or the like. Alternatively, the apparatus may be embodied by or associated with a fixed computing device, such as a computer workstation, a personal computer, a server, or the like.

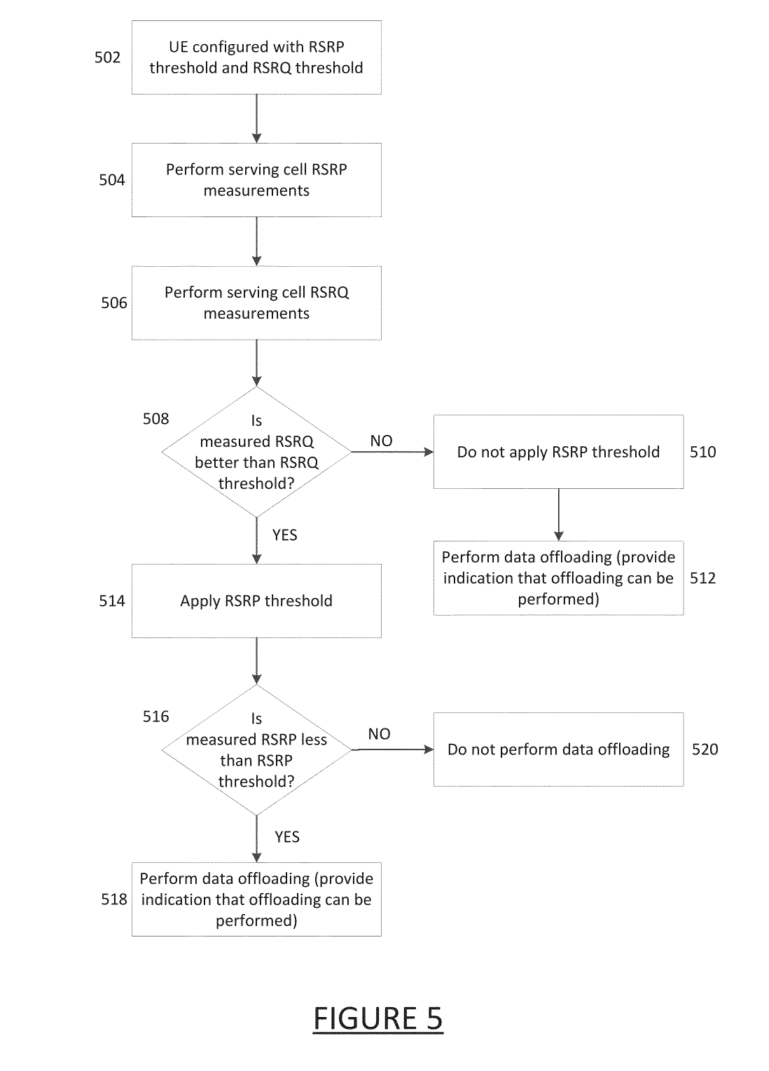

An apparatus 200 may be configured to perform one or more of the operations set forth by FIGS. 5 through 7, and also described below, in accordance with an example embodiment of the present invention. In this regard, the apparatus may be embodied by or as part of the user equipment 108, serving base station 102, or wireless access point 106 as shown in FIG. 1, for example.

Regardless of the manner in which apparatus 200 is embodied, the apparatus of the embodiment of FIG. 2 may include or otherwise be in communication with one or more of one or more processors 202, one or more memory devices 204, one or more communication interfaces 206, and optionally, one or more user interfaces 208. In instances in which the apparatus is embodied by a serving base station 102, or wireless access point 106, or the like, the apparatus need not necessarily include a user interface. As such, some components have been illustrated in dashed lines to indicate that not all instantiations of the apparatus need include those components.

In some embodiments, the processor (and/or co-processors or any other processing circuitry assisting or otherwise associated with the processor) may be in communication with the memory device via a bus for passing information among components of the apparatus. The memory device may include, for example, a non-transitory memory, such as one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

In some embodiments, the apparatus 200 may be embodied as a chip or chip set. In other words, the apparatus may comprise one or more physical packages (for example, chips) including materials, components and/or wires on a structural assembly (for example, a circuit board). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 202 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 202 may be configured to execute instructions stored in the one or more memory devices 204 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA, or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the user equipment 108, the base station 102, and/or the wireless access point 106) configured to employ an embodiment of the present invention by further configuration of the processor by instructions for performing the algorithms and/or operations described herein. The processor may include, among other things, a clock, an arithmetic logic unit (ALU), and logic gates configured to support operation of the processor.

The communication interface 206 may be any means such as a device or circuitry embodied in either hardware or a combination of hardware and software that is configured to receive and/or transmit data from/to a network and/or any other device or module in communication with the apparatus 200, such as by supporting communications with the base station 102 and the wireless access point 106. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB), or other mechanisms.

The apparatus 200 of the illustrated embodiment may also optionally include one or more user interfaces 208 that may, in turn, be in communication with the processor 202 to provide output to the user and, in some embodiments, to receive an indication of a user input. For example, the user interface may include a display and, in some embodiments, may also include a keyboard, a mouse, a joystick, a touch screen, touch areas, soft keys, a microphone, a speaker, multiples of the aforementioned user interfaces, and/or other input/output mechanisms. In an example embodiment, the processor may comprise user interface circuitry configured to control at least some functions of one or more user interface elements such as a display and, in some embodiments, a speaker, ringer, microphone, and/or the like. The processor and/or user interface circuitry comprising the processor may be configured to control one or more functions of one or more user interface elements through computer program instructions (for example, software and/or firmware) stored on a memory accessible to the processor (for example, memory device 204, and/or the like).

It should also be noted that while FIG. 2 illustrates one example of a configuration of an apparatus 200 configured to provide operations to facilitate data offloading, numerous other configurations may also be used to implement other embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

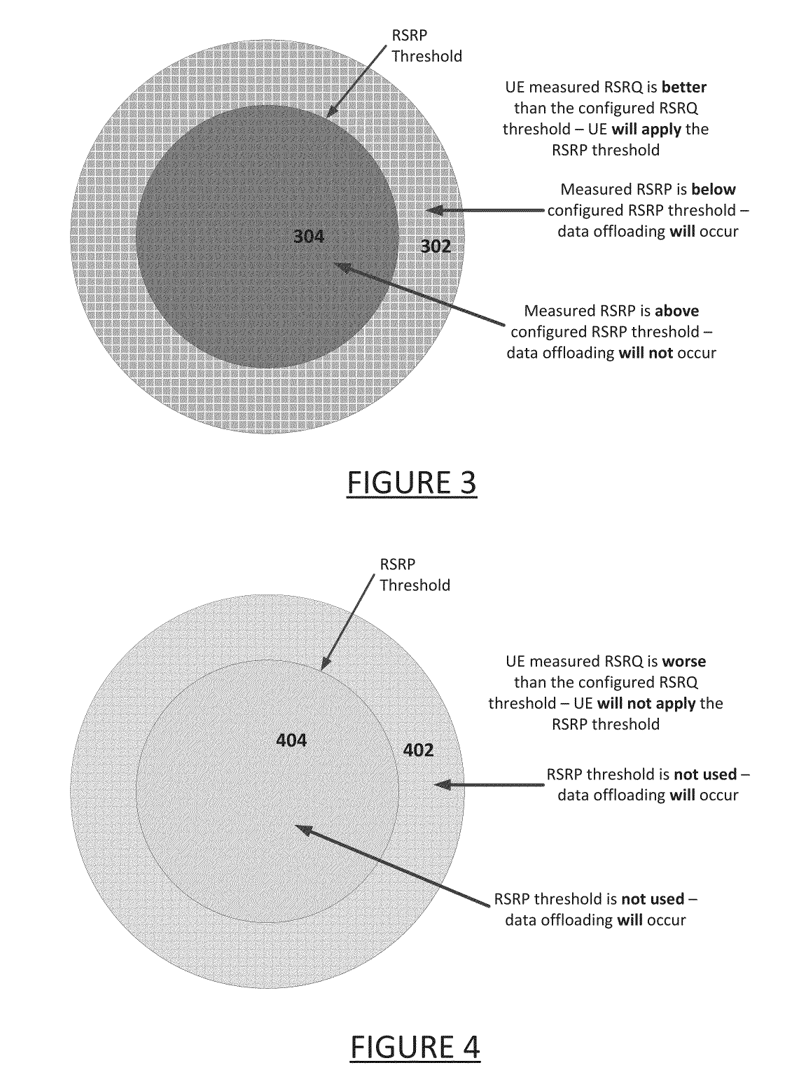

FIGS. 3 and 4 illustrate principles of the application of the RSRQ and RSRP thresholds in data offloading in accordance with an example embodiment of the present invention. FIG. 3 illustrates an example embodiment where the measured RSRQ is better than the defined RSRQ threshold (low load condition), so the UE will apply the RSRP offloading threshold to determine whether offloading should be performed. In region 302, the measured RSRP is lower than the RSRP threshold, and since the load condition of the serving cell is low, offloading will occur. In region 304, the measured RSRP is greater than the RSRP threshold so offloading will not be performed.

FIG. 4 illustrates an example embodiment where the measured RSRQ is worse than the defined RSRQ threshold (high load condition), so the UE will not apply the RSRP offloading threshold to determine whether offloading should be performed. In region 404, due to the high load condition, even though the RSRP measurements may be lower than the defined threshold, the RSRP offloading threshold will not be applied and offloading will be performed. In region 402, offloading will be performed as well with the RSRP offloading threshold being ignored due to the high load condition.

Referring now to FIG. 5, the operations performed, such as by apparatus 200 of FIG. 2, to facilitate load based changes to offloading thresholds in accordance with an example embodiment are illustrated. As shown in block 502, the apparatus may include means, such as the processor 202 or the like, for configuring the apparatus with an RSRP offloading threshold and an RSRQ threshold. For example, an apparatus, such as UE 108, may receive signals from a serving cell of a cellular network, such as from serving BS 102, indicating the RSRP offloading threshold and an RSRQ threshold that should be configured in the UE.

As shown in block 504, the apparatus may include means, such as the processor 202 or the like, for causing the apparatus to continuously perform RSRP measurements of the serving cell, while the UE is in the serving cell, for use in evaluating whether offloading to another detected available network or cell should be performed. As shown in block 506, the apparatus may include means, such as the processor 202 or the like, for causing the apparatus to continuously perform RSRQ measurements of the serving cell, while the UE is in the serving cell, for use in evaluating whether offloading thresholds should be applied. While the measurement operations of blocks 504 and 506 are illustrated as being performed in sequence with block 506 following block 504, in various embodiments, the measurement operations may be performed in any order or may be performed concurrently.

As shown in block 508, the apparatus may include means, such as the processor 202 or the like, for determining whether the measured RSRQ crosses the RSRQ threshold. If the measured RSRQ crosses the RSRQ threshold, operations may proceed to block 510 and the apparatus may be caused to not apply the RSRP threshold in a decision of whether to perform offloading (ignore the threshold), and operations will proceed to block 512.

As shown in block 512, the apparatus may include means, such as the processor 202 or the like, for causing offloading from the cellular network to another network or cell to be performed, for example because the load on the serving cell is high.

If, at block 508, the measured RSRQ does not cross the RSRQ threshold, operations may proceed to block 514 where the apparatus may be caused to apply the RSRP offloading threshold in a decision of whether to perform offloading, and operations will proceed to block 516.

As shown in block 516, the apparatus may include means, such as the processor 202 or the like, for determining whether the measured RSRP crosses the RSRP offloading threshold. If the measured RSRP crosses the RSRP offloading threshold, operations may proceed to block 518. As shown in block 518, the apparatus may include means, such as the processor 202 or the like, for causing offloading from the cellular network to another network or cell to be performed (or cause an indication to be provided, such as to other control circuitry, that offloading can be performed). If the measured RSRP does not cross the RSRP offloading threshold, operations may proceed to block 520 and the apparatus may be caused to not perform offloading.

While described herein, and illustrated in FIGS. 5-8, as a single sequence of measurement and determination operations, embodiments may perform the RSRP and RSRQ measurements as well as the determinations of whether to apply the RSRP threshold and whether to perform data offloading as a continuous or repeating process or series of operations.

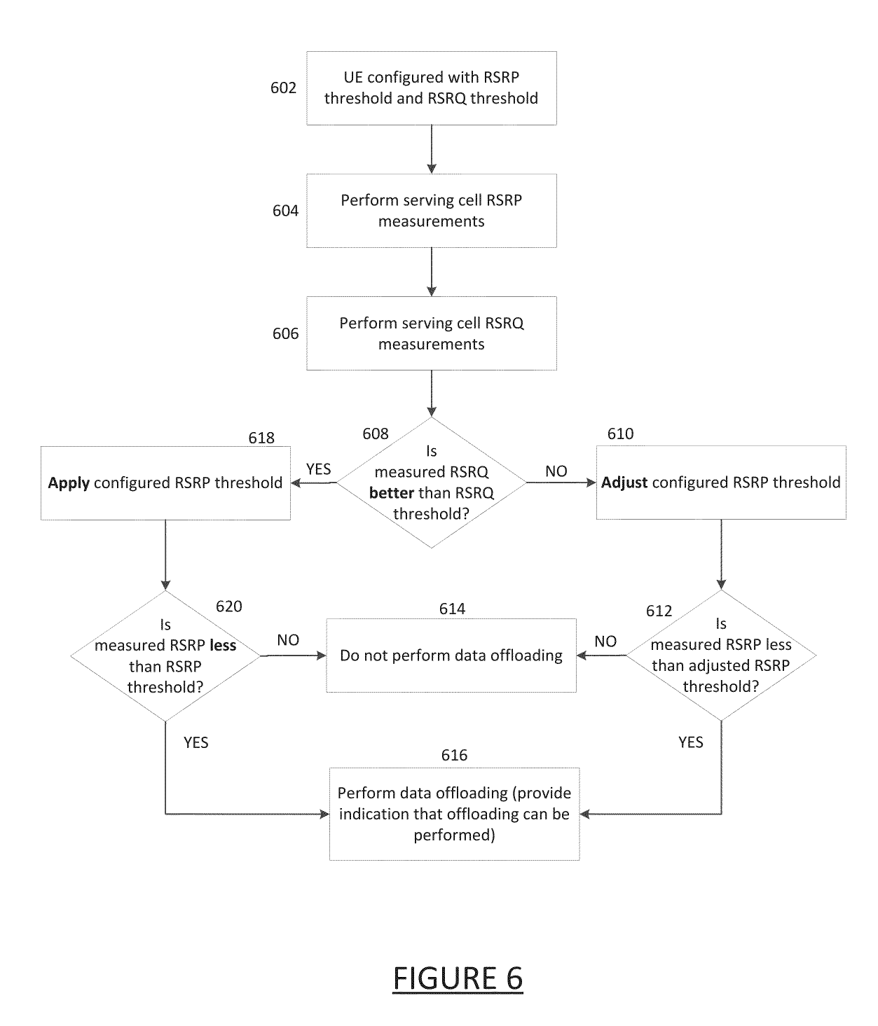

Referring now to FIG. 6, the operations performed, such as by apparatus 200 of FIG. 2, to facilitate load based changes to offloading thresholds in accordance with another example embodiment are illustrated. As shown in block 602, the apparatus may include means, such as the processor 202 or the like, for configuring the apparatus with an RSRP offloading threshold and an RSRQ threshold. For example, an apparatus, such as UE 108, may receive signals from a serving cell of a cellular network, such as from serving BS 102, indicating the RSRP offloading threshold and an RSRQ threshold that should be configured in the UE.

As shown in block 604, the apparatus may include means, such as the processor 202 or the like, for causing the apparatus to continuously perform RSRP measurements of the serving cell, while the UE is in the serving cell, for use in evaluating whether offloading to another detected available network or cell should be performed. As shown in block 606, the apparatus may include means, such as the processor 202 or the like, for causing the apparatus to continuously perform RSRQ measurements of the serving cell, while the UE is in the serving cell, for use in evaluating whether offloading thresholds should be applied or adjusted. While the measurement operations of blocks 604 and 606 are illustrated as being performed in sequence with block 606 following block 604, in various embodiments, the measurement operations may be performed in any order or may be performed concurrently.

As shown in block 608, the apparatus may include means, such as the processor 202 or the like, for determining whether the measured RSRQ crosses the RSRQ threshold. If the measured RSRQ crosses the RSRQ threshold (608—NO), operations may proceed to block 610. As shown in block 608, the apparatus may include means, such as the processor 202 or the like, for causing the configured RSRP offloading threshold to be adjusted (for example, lowered because the load of the serving cell high) before being applied in making an offloading decision. Operations may then continue to block 612.

As shown in block 612, the apparatus may include means, such as the processor 202 or the like, for determining whether the measured RSRP crosses the adjusted RSRP offloading threshold. If the measured RSRP does not cross the adjusted RSRP offloading threshold (612—NO), operations may proceed to block 614 and the apparatus may be caused to not perform offloading. If the measured crosses the adjusted RSRP offloading threshold (612—YES), operations may proceed to block 616. As shown in block 616, the apparatus may include means, such as the processor 202 or the like, for causing offloading from the cellular network to another network or cell to be performed.

If, at block 608, the measured RSRQ does not cross the RSRQ threshold (608—YES), operations may proceed to block 618 where the apparatus may be caused to apply the configured RSRP offloading threshold in a decision of whether to perform offloading, and operations will proceed to block 620.

As shown in block 620, the apparatus may include means, such as the processor 202 or the like, for determining whether the measured RSRP crosses the configured RSRP offloading threshold. If the measured RSRP does not cross the configured RSRP offloading threshold (620—NO), operations may proceed to block 614 and the apparatus may be caused to not perform offloading. If the measured RSRP crosses the adjusted RSRP offloading threshold (620—YES), operations may proceed to block 616. As shown in block 616, the apparatus may include means, such as the processor 202 or the like, for causing offloading from the cellular network to another network or cell to be performed.

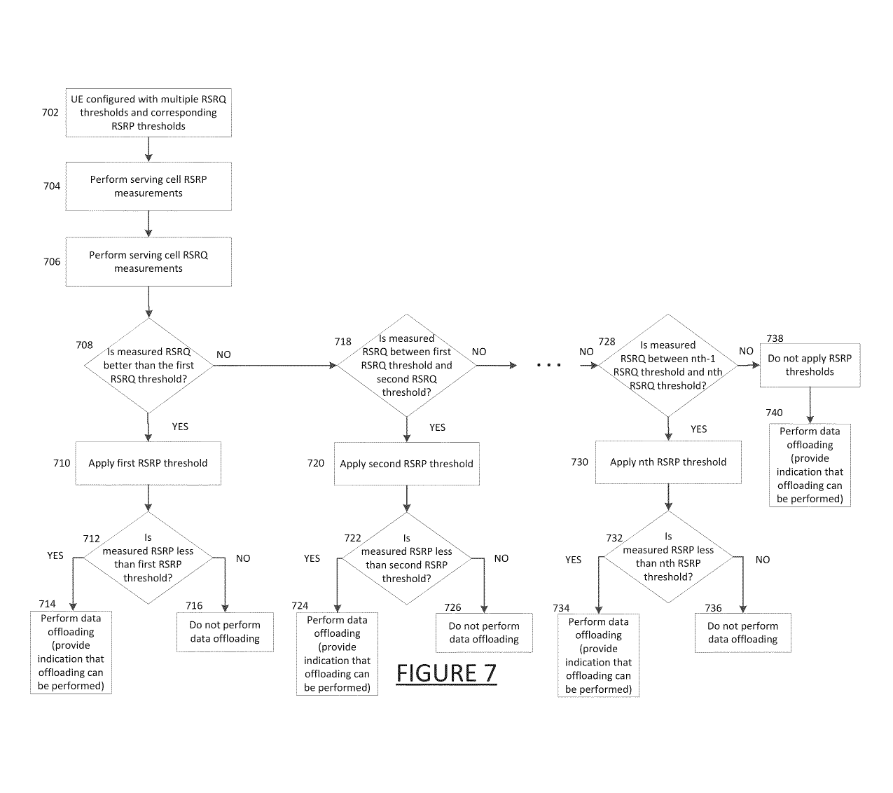

Referring now to FIG. 7, the operations performed, such as by apparatus 200 of FIG. 2, to facilitate load based changes to offloading thresholds in accordance with another example embodiment are illustrated. As shown in block 702, the apparatus may include means, such as the processor 202 or the like, for configuring the apparatus with multiple RSRQ thresholds and corresponding RSRP offloading thresholds. For example, an apparatus, such as UE 108, may receive signals from a serving cell of a cellular network, such as from serving BS 102, indicating the RSRQ thresholds and RSRP offloading threshold and an that should be configured in the UE.

For example, the multiple RSRQ thresholds and the corresponding RSRP offloading thresholds may be defined such that a first RSRQ threshold is the first RSRQ threshold and the nth RSRQ threshold is the last RSRQ threshold. In such an instance, when the measured RSRQ does not cross a first RSRQ threshold then a corresponding first RSRP offloading threshold is applied; when the measured RSRQ crosses the first RSRQ threshold but does not cross a second RSRQ, a corresponding second RSRP offloading threshold is applied; when the measured RSRQ crosses the n−1 RSRQ threshold but does not cross a nth RSRQ threshold, a corresponding nth RSRP offloading threshold is applied; and when the measured RSRQ crosses the nth RSRQ threshold, the RSRP offloading thresholds are ignored.

As shown in block 704, the apparatus may include means, such as the processor 202 or the like, for causing the apparatus to continuously perform RSRP measurements of the serving cell, while the UE is in the serving cell, for use in evaluating whether offloading to another detected available network or cell should be performed. As shown in block 706, the apparatus may include means, such as the processor 202 or the like, for causing the apparatus to continuously perform RSRQ measurements of the serving cell, while the UE is in the serving cell, for use in evaluating whether offloading thresholds should be applied or adjusted. While the measurement operations of blocks 704 and 706 are illustrated as being performed in sequence with block 706 following block 704, in various embodiments, the measurement operations may be performed in any order or may be performed concurrently.

As shown in block 708, the apparatus may include means, such as the processor 202 or the like, for determining whether the measured RSRQ crosses a first RSRQ threshold. If the measured RSRQ does not cross a first RSRQ threshold (708—YES), operations may proceed to block 710 where the apparatus may be caused to apply a first RSRP offloading threshold in a decision of whether to perform offloading, and operations will proceed to block 712.

As shown in block 712, the apparatus may include means, such as the processor 202 or the like, for determining whether the measured RSRP crosses a first RSRP offloading threshold. If the measured RSRP crosses the first RSRP offloading threshold (712—YES), operations may proceed to block 714. As shown in block 714, the apparatus may include means, such as the processor 202 or the like, for causing offloading from the cellular network to another network or cell to be performed. If the measured RSRP does not cross the first RSRP offloading threshold (712—NO), operations may proceed to block 716 and the apparatus may be caused to not perform offloading.

If, at block 708, the measured RSRQ crosses the first RSRQ threshold (708—NO), operations may proceed to block 718.

As shown in block 718, the apparatus may include means, such as the processor 202 or the like, for determining whether the measured RSRQ crosses a second RSRQ threshold (e.g., worse than the first RSRQ threshold but better than the second RSRQ threshold). If the measured crosses the first RSRQ threshold and does not cross the second RSRQ threshold (718—YES), operations may proceed to block 720 where the apparatus may be caused to apply a second RSRP offloading threshold in a decision of whether to perform offloading, and operations will proceed to block 722.

As shown in block 722, the apparatus may include means, such as the processor 202 or the like, for determining whether the measured RSRP crosses a second RSRP offloading threshold. If the measured RSRP crosses the second RSRP offloading threshold (722—YES), operations may proceed to block 724. As shown in block 724, the apparatus may include means, such as the processor 202 or the like, for causing offloading from the cellular network to another network or cell to be performed. If the measured RSRP does not cross the second RSRP offloading threshold (722—NO), operations may proceed to block 726 and the apparatus may be caused to not perform offloading.

If, at block 718, the measured RSRQ crosses the second RSRQ threshold (718—NO), operations may proceed in a similar fashion for each of the succeeding RSRQ thresholds. When the determination is made that the measured RSRQ crosses an nth−1 RSRQ threshold, operations will proceed to block 728.

As shown in block 728, the apparatus may include means, such as the processor 202 or the like, for determining whether the measured RSRQ crosses an nth RSRQ threshold (e.g., worse that the nth−1 RSRQ threshold but better than the nth RSRQ threshold). If the measured RSRQ does not cross the nth RSRQ threshold (728—YES), operations may proceed to block 730 where the apparatus may be caused to apply an nth RSRP offloading threshold in a decision of whether to perform offloading, and operations will proceed to block 732.

As shown in block 732, the apparatus may include means, such as the processor 202 or the like, for determining whether the measured RSRP crosses an nth RSRP offloading threshold. If the measured RSRP crosses the nth RSRP offloading threshold (732—YES), operations may proceed to block 734. As shown in block 734, the apparatus may include means, such as the processor 202 or the like, for causing offloading from the cellular network to another network or cell to be performed. If the measured RSRP does not cross the nth RSRP offloading threshold (732—NO), operations may proceed to block 736 and the apparatus may be caused to not perform offloading.

If, at block 728, the measured RSRQ crosses the nth RSRQ threshold (728—NO), operations may proceed to block 738 and the apparatus may be caused to not apply any of the RSRP thresholds in a decision of whether to perform offloading (ignore the thresholds), and operations will proceed to block 740.

As shown in block 740, the apparatus may include means, such as the processor 202 or the like, for causing offloading from the cellular network to another network or cell to be performed, for example because the load on the serving cell is too high.

Additionally, an example embodiment of the present invention may perform data offloading in multiple manners, such as offloading from a cell of a cellular network to another wireless network, such as a WLAN; from a cell of a first network to an overlapping cell of a second network; between overlapping cells of a single network; from a wireless network, such as a WLAN, to a cell of a cellular network; and the like. The operations described herein in regard to FIGS. 5-7 are not intended to be limited only to embodiments wherein offloading occurs from a cell to a second wireless network.

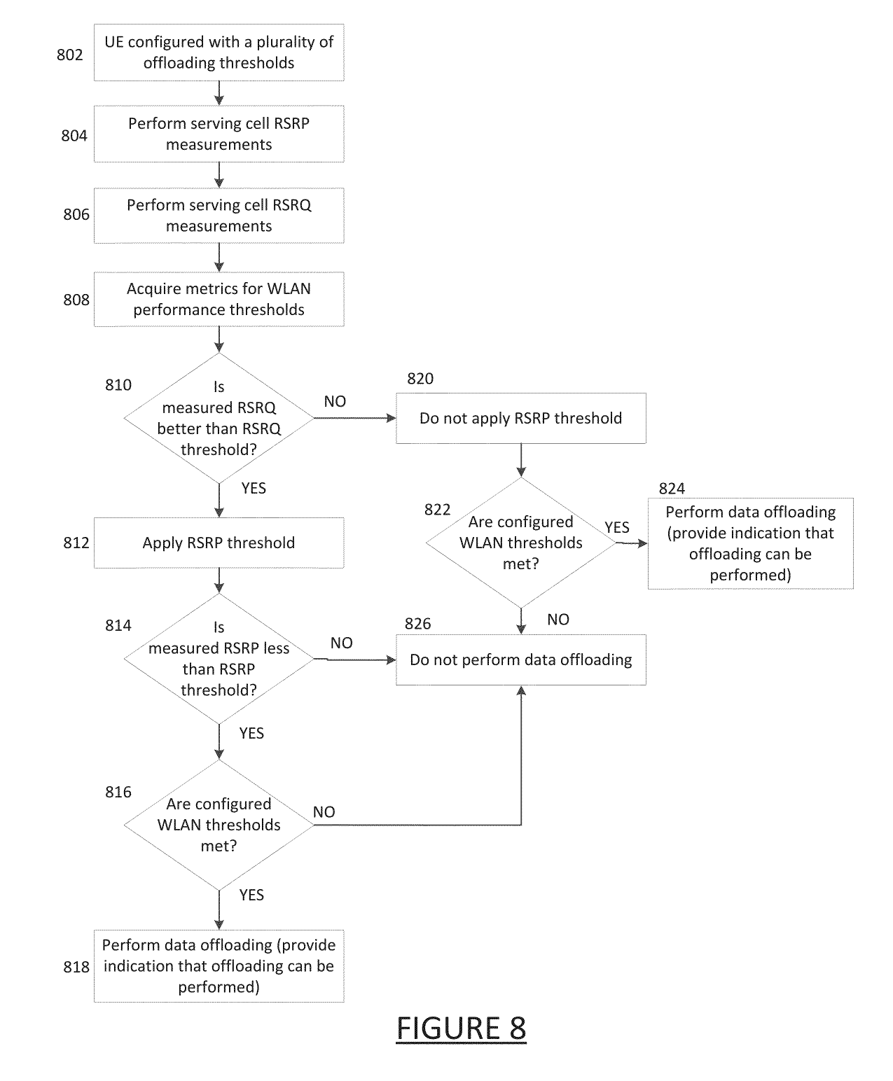

Referring now to FIG. 8, the operations performed, such as by apparatus 200 of FIG. 2, to facilitate offloading based on a plurality of configured offloading thresholds in accordance with an example embodiment are illustrated. As shown in block 802, the apparatus may include means, such as the processor 202 or the like, for configuring the apparatus with a plurality of thresholds, such as one or more of RSRP offloading thresholds (e.g., low, high), RSRQ thresholds (e.g., low, high for different RSRQ metrics), channel utilization thresholds (e.g., low, high), backhaul downlink bandwidth or rate (e.g., low, high), backhaul uplink bandwidth or rate (e.g., low, high), beacon received signal strength indicator threshold (e.g., low, high), or the like. For example, an apparatus, such as UE 108, may receive signals from a serving cell of a cellular network, such as from serving BS 102, indicating the thresholds that should be configured in the UE.

As shown in block 804, the apparatus may include means, such as the processor 202 or the like, for causing the apparatus to continuously perform RSRP measurements of the serving cell, while the UE is in the serving cell, for use in evaluating whether offloading to another detected available network or cell should be performed. As shown in block 806, the apparatus may include means, such as the processor 202 or the like, for causing the apparatus to continuously perform RSRQ measurements of the serving cell, while the UE is in the serving cell, for use in evaluating whether offloading thresholds should be applied. While the measurement operations of blocks 804 and 806 are illustrated as being performed in sequence with block 806 following block 804, in various embodiments, the measurement operations may be performed in any order or may be performed concurrently.

As shown in block 808, the apparatus may include means, such as the processor 202 or the like, for causing the apparatus to attain performance metrics for the alternate available network for which offloading of traffic is being considered, such as a WLAN, based on the configured thresholds. For example, the apparatus may attain measurements for one or more of channel, backhaul downlink bandwidth or rate, backhaul uplink bandwidth or rate, beacon received signal strength indicator, or the like, depending on which thresholds have been configured in the apparatus.

As shown in block 812, the apparatus may include means, such as the processor 202 or the like, for determining whether the measured RSRQ crosses the configured RSRQ threshold (e.g., whether the RSRQ measurement is below a configured low threshold). If, at block 812, the measured RSRQ does not cross the RSRQ threshold (e.g., is above a configured “low” threshold), operations may proceed to block 812 where the apparatus may be caused to apply the RSRP offloading threshold in a decision of whether to perform offloading, and operations will proceed to block 814.

As shown in block 814, the apparatus may include means, such as the processor 202 or the like, for determining whether the measured RSRP crosses the RSRP offloading threshold (e.g., measured RSRP is below a “low” threshold). If the measured RSRP crosses the RSRP offloading threshold, operations may proceed to block 816.

As shown in block 816, the apparatus may include means, such as the processor 202 or the like, for determining whether the metrics for the available network meet the configured thresholds, for example, the WLAN metric thresholds (e.g., low channel utilization, high backhaul downlink or uplink rate, high received signal strength indicator). If the WLAN metrics cross the configured thresholds, operations may proceed to block 818. As shown in block 818, the apparatus may include means, such as the processor 202 or the like, for causing offloading from the cellular network to another network, such as the WLAN, to be performed. If the WLAN metrics do not cross the configured offloading thresholds, operations may proceed to block 826 and the apparatus may be caused to not perform offloading.

If, at block 810, the measured RSRQ crosses the RSRQ threshold (e.g., measure RSRQ is below a “low” threshold), operations may proceed to block 820 and the apparatus may be caused to not apply the RSRP threshold in a decision of whether to perform offloading (ignore the threshold), and operations will proceed to block 822.

As shown in block 822, the apparatus may include means, such as the processor 202 or the like, for determining whether the metrics for the available network meet the configured thresholds, for example, the WLAN metric thresholds (e.g., low channel utilization, high backhaul downlink or uplink rate, high received signal strength indicator). If the WLAN metrics cross the configured thresholds, operations may proceed to block 824. As shown in block 824, the apparatus may include means, such as the processor 202 or the like, for causing offloading from the cellular network to another network, such as the WLAN, to be performed. If the WLAN metrics do not cross the configured offloading thresholds, operations may proceed to block 826 and the apparatus may be caused to not perform offloading.

As described above, FIGS. 5 through 8 illustrate flowcharts of an apparatus, method, and computer program product according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 204 of an apparatus employing an embodiment of the present invention and executed by a processor 202 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

### Additional Embodiments

In one embodiment a method is provided, the method comprising causing measurement of a reference signal received power measurement of a serving cell in a first network to be performed; causing measurement of a reference signal received quality measurement of a serving cell in the first network to be performed; determining, by a processor, whether the measured reference signal received quality measurement is higher than the reference signal received quality threshold; in the case where the measured reference signal received quality measurement is lower than the reference signal received quality threshold, causing the reference signal received power threshold to be ignored and causing data offloading to a second available network or cell; and in the case where the measured reference signal received quality measurement is higher than the reference signal received quality threshold, determining, by the processor, whether the measured reference signal received power measurement is lower than the reference signal received power threshold; in the case where the measured reference signal received power measurement is lower than the reference signal received power threshold, causing data offloading to a second available network or cell; and in the case where the measured reference signal received power measurement is higher than the reference signal received power threshold, causing data offloading to not be performed.

In some embodiments, the method may further comprise receiving a reference signal received power threshold from the first network; and receiving a reference signal received quality threshold from the first network.

In one embodiment a method is provided, the method comprising: causing measurement of a reference signal received power measurement of a serving cell in a first network to be performed; causing measurement of a reference signal received quality measurement of a serving cell in the first network to be performed; determining, by a processor, whether the measured reference signal received quality measurement is higher than the reference signal received quality threshold; in the case where the measured reference signal received quality measurement is higher than the reference signal received quality threshold, determining, by the processor, whether the measured reference signal received power measurement is lower than the reference signal received power threshold; in the case where the measured reference signal received power measurement is lower than the reference signal received power threshold, causing data offloading to a second available network or cell; in the case where the measured reference signal received quality measurement is lower than the reference signal received quality threshold, causing the reference signal received power threshold to be adjusted; determining, by the processor, whether the measured reference signal received power measurement is lower than the adjusted reference signal received power threshold; and in the case where the measured reference signal received power measurement is lower than the adjusted reference signal received power threshold, causing data offloading to a second available network or cell.

In some embodiments, the method may further comprise receiving a reference signal received power threshold from the first network; and receiving a reference signal received quality threshold from the first network.

In some embodiments, the method may further comprise wherein the adjusting of the reference signal received power threshold comprises one of: reducing the reference signal received power threshold; or using an alternate reference signal received power threshold received from the first network.

In one embodiment a method is provided, the method comprising: receiving two or more reference signal received quality thresholds from the first network; receiving two or more reference signal received power thresholds from a first network, wherein each of the two or more reference signal received power thresholds corresponds to one of the two or more reference signal received quality thresholds; causing measurement of a reference signal received power measurement of a serving cell in the first network to be performed; causing measurement of a reference signal received quality measurement of a serving cell in the first network to be performed; determining, by a processor, whether the measured reference signal received quality measurement is higher than a first reference signal received quality threshold of the two or more reference signal received quality thresholds; in the case where the measured reference signal received quality measurement is higher than the first reference signal received quality threshold, determining, by the processor, whether the measured reference signal received power measurement is lower than a corresponding first reference signal received power threshold; in the case where the measured reference signal received power measurement is lower than the first reference signal received power threshold, causing data offloading to a second available network or cell; in the case where the measured reference signal received quality measurement is lower than the first reference signal received quality threshold, determining, by the processor, whether the measured reference signal received quality measurement is higher than a second reference signal received quality threshold of the two or more reference signal received quality thresholds; in the case where the measured reference signal received quality measurement is higher than the second reference signal received quality threshold, determining, by the processor, whether the measured reference signal received power measurement is lower than a corresponding second reference signal received power threshold; in the case where the measured reference signal received power measurement is lower than the second reference signal received power threshold, causing data offloading to a second available network or cell; and in the case where the measured reference signal received quality measurement is lower than the second reference signal received quality threshold, ignoring the two or more reference signal received power thresholds and causing data offloading to a second available network or cell.

In one embodiment, an apparatus is provided, the apparatus comprising at least one processor and at least one memory including computer program code, the at least one memory and the computer program code configured to, with the at least one processor, cause the apparatus at least to: cause measurement of a reference signal received power measurement of a serving cell in the first network to be performed; cause measurement of a reference signal received quality measurement of a serving cell in the first network to be performed; determine whether the measured reference signal received quality measurement is higher than the reference signal received quality threshold; in the case where the measured reference signal received quality measurement is lower than the reference signal received quality threshold, cause the reference signal received power threshold to be ignored and cause data offloading to a second available network or cell; and in the case where the measured reference signal received quality measurement is higher than the reference signal received quality threshold, determine whether the measured reference signal received power measurement is lower than the reference signal received power threshold; and in the case where the measured reference signal received power measurement is lower than the reference signal received power threshold, cause data offloading to a second available network or cell.

In some embodiments, the apparatus further comprises the at least one memory and the computer program code configured to, with the at least one processor, cause the apparatus at least to: receive a reference signal received power threshold from the first network; and receive a reference signal received quality threshold from the first network.

In one embodiment, a computer program product is provided, the computer program product comprising at least one non-transitory computer-readable storage medium bearing computer program code portions embodied therein for use with a computer, the computer program code portions comprising program code instructions configured, upon execution, to: cause measurement of a reference signal received power measurement of a serving cell in the first network to be performed; cause measurement of a reference signal received quality measurement of a serving cell in the first network to be performed; determine whether the measured reference signal received quality measurement is higher than the reference signal received quality threshold; in the case where the measured reference signal received quality measurement is lower than the reference signal received quality threshold, cause the reference signal received power threshold to be ignored and cause data offloading to a second available network or cell; and in the case where the measured reference signal received quality measurement is higher than the reference signal received quality threshold, determine whether the measured reference signal received power measurement is lower than the reference signal received power threshold; and in the case where the measured reference signal received power measurement is lower than the reference signal received power threshold, cause data offloading to a second available network or cell.

In some embodiments, the computer program product further comprises program code instructions configured, upon execution, to: receive a reference signal received power threshold from the first network; and receive a reference signal received quality threshold from the first network.

In one embodiment a method is provided, the method comprising: causing measurement of a reference signal received power of a serving cell in a first network to be performed; causing measurement of a reference signal received quality of a serving cell in the first network to be performed; causing one or more network metrics for a second network to be acquired; determining, by a processor, whether the measured reference signal received quality is lower than a reference signal received quality low threshold; in the case where the measured reference signal received quality is lower than the reference signal received quality low threshold, determining whether each of the acquired network metrics for the second network meet an associated network metric condition; and if all the associated network metric conditions are met, causing data offloading to be performed from the first network to the second network; and in the case where the measured reference signal received quality is higher than the reference signal received quality low threshold, determining, by the processor, whether the measured reference signal received power is lower than the reference signal received power low threshold; in the case where the measured reference signal received power is lower than the reference signal received power low threshold, determining whether each of the acquired network metrics for the second network meet an associated network metric condition; and if all the associated network metric conditions are met, causing data offloading to the second available network or cell; and in the case where the measured reference signal received power is higher than the reference signal received power low threshold, causing data offloading to not be performed.

In some embodiments, the method may further comprise wherein the network metrics for the second network comprise one or more of: channel utilization, backhaul downlink bandwidth, backhaul uplink bandwidth, and received signal strength indicator.

In some embodiments, the method may further comprise receiving a reference signal received power threshold from the first network; receiving a reference signal received quality threshold from the first network; and receiving one or more network metric conditions from the first network.

In some embodiments, the method may further comprise wherein the second available network is a wireless local area network.

In some embodiments, the method may further comprise determining, by the processor, whether the measured reference signal received power is higher than a high reference signal received power threshold; determining, by the processor, whether the measured reference signal received quality is higher than a high reference signal received quality threshold; determining, by the processor, whether each of the acquired one or more network metrics for the second network meets an associated second network metric condition; and if the high reference signal received power s higher than the high reference signal received power threshold and the high reference signal received quality is higher than the high reference signal received quality threshold, causing data offloading from the second available network to the first network to be performed; or if one or more of the acquired one or more network metrics meets an associated second network metric condition, causing data offloading from the second available network to the first network to be performed.

In some embodiments, the method may further comprise: receiving a high reference signal received power threshold from the first network; receiving a high reference signal received quality threshold from the first network; and receiving one or more second network metric conditions from the first network.

In one embodiment, an apparatus is provided, the apparatus comprising at least one processor and at least one memory including computer program code, the at least one memory and the computer program code configured to, with the at least one processor, cause the apparatus at least to: cause measurement of a reference signal received power of a serving cell in a first network to be performed; cause measurement of a reference signal received quality of a serving cell in the first network to be performed; cause one or more network metrics for a second network to be acquired; determine whether the measured reference signal received quality is lower than a reference signal received quality low threshold; in the case where the measured reference signal received quality is lower than the reference signal received quality low threshold, determine whether each of the acquired network metrics for the second network meet an associated network metric condition; and if all the associated network metric conditions are met, cause data offloading to be performed from the first network to the second network; and in the case where the measured reference signal received quality is higher than the reference signal received quality low threshold, determine whether the measured reference signal received power is lower than the reference signal received power low threshold; in the case where the measured reference signal received power is lower than the reference signal received power low threshold, determine whether each of the acquired network metrics for the second network meet an associated network metric condition; and if all the associated network metric conditions are met, cause data offloading to the second available network or cell; and in the case where the measured reference signal received power is higher than the reference signal received power low threshold, cause data offloading to not be performed.

In some embodiments, the apparatus further comprises the at least one memory and the computer program code configured to, with the at least one processor, cause the apparatus at least to: determine whether the measured reference signal received power is higher than a high reference signal received power threshold; determine whether the measured reference signal received quality is higher than a high reference signal received quality threshold; determine whether each of the acquired one or more network metrics for the second network meets an associated second network metric condition; and if the high reference signal received power s higher than the high reference signal received power threshold and the high reference signal received quality is higher than the high reference signal received quality threshold, cause data offloading from the second available network to the first network to be performed; or if one or more of the acquired one or more network metrics meets an associated second network metric condition, cause data offloading from the second available network to the first network to be performed.

In one embodiment a method is provided, the method comprising causing measurement of a reference signal received power of a serving cell in the first network to be performed; causing measurement of a reference signal received quality of a serving cell in the first network to be performed; causing one or more network metrics for a second network to be acquired; determining, by a processor, whether the measured reference signal received quality is lower than a reference signal received quality threshold; determining, by the processor, whether the measured reference signal received power is lower than a reference signal received power threshold; and in the case where the measured reference signal received quality is lower than the reference signal received quality threshold or the measured reference signal received power is lower than the reference signal received power threshold: determining, by the processor, whether each of the acquired network metrics for the second network meet an associated network metric condition; and if all the associated network metric conditions are met, causing or allowing data offloading to be performed from the first network to the second network.

In some embodiments, the method may further comprise wherein the network metrics for the second network comprise one or more of: channel utilization, backhaul downlink bandwidth, backhaul uplink bandwidth, and received signal strength indicator.

In some embodiments, the method may further comprise receiving the reference signal received power threshold from the first network; receiving the reference signal received quality threshold from the first network; and receiving one or more network metric thresholds from the first network.

In some embodiments, the method may further comprise wherein the second network is a wireless local area network.

In one embodiment a method is provided, the method comprising causing measurement of a reference signal received power of a serving cell in the first network; causing measurement of a reference signal received quality of a serving cell in the first network; causing one or more network metrics for a second network to be acquired; determining, by a processor, whether the measured reference signal received quality is higher than a reference signal received quality threshold; determining, by the processor, whether the measured reference signal received power is higher than a reference signal received power threshold; comparing each of the acquired network metrics for the second network to an associated network metric condition; and in the case where the measured reference signal received quality is higher than the reference signal received quality threshold and the measured reference signal received power is higher than the reference signal received power threshold, causing or allowing data offloading to be performed from the second network to the first network; or in the case where one or more of the acquired network metrics for the second network meets the associated network metric condition, causing or allowing data offloading to be performed from the second network to the first network.

In some embodiments, the method may further comprise wherein the network metrics for the second network comprise one or more of channel utilization, backhaul downlink bandwidth, backhaul uplink bandwidth, and received signal strength indicator.

In some embodiments, the method may further comprise: receiving the reference signal received power threshold from the first network; receiving the reference signal received quality threshold from the first network; and receiving one or more network metric thresholds from the first network.

In some embodiments, the method may further comprise wherein the second network is a wireless local area network.

In one embodiment, an apparatus is provided, the apparatus comprising at least one processor and at least one memory including computer program code, the at least one memory and the computer program code configured to, with the at least one processor, cause the apparatus at least to cause measurement of a reference signal received power of a serving cell in the first network to be performed; cause measurement of a reference signal received quality of a serving cell in the first network to be performed; cause one or more network metrics for a second network to be acquired; determine whether the measured reference signal received quality is lower than a reference signal received quality threshold; determine whether the measured reference signal received power is lower than a reference signal received power threshold; and in the case where the measured reference signal received quality is lower than the reference signal received quality threshold or the measured reference signal received power is lower than the reference signal received power threshold: determine whether each of the acquired network metrics for the second network meet an associated network metric condition; and if all the associated network metric conditions are met, cause or allow data offloading to be performed from the first network to the second network.

In some embodiments, the apparatus further comprises wherein the network metrics for the second network comprise one or more of: channel utilization, backhaul downlink bandwidth, backhaul uplink bandwidth, and received signal strength indicator.

In some embodiments, the apparatus further comprises the at least one memory and the computer program code configured to, with the at least one processor, cause the apparatus at least to: receive the reference signal received power threshold from the first network; receive the reference signal received quality threshold from the first network; and receive one or more network metric thresholds from the first network.

In some embodiments, the apparatus further comprises wherein the second network is a wireless local area network.

In one embodiment, an apparatus is provided, the apparatus comprising at least one processor and at least one memory including computer program code, the at least one memory and the computer program code configured to, with the at least one processor, cause the apparatus at least to cause measurement of a reference signal received power of a serving cell in the first network; cause measurement of a reference signal received quality of a serving cell in the first network; cause one or more network metrics for a second network to be acquired; determine whether the measured reference signal received quality is higher than a reference signal received quality threshold; determine whether the measured reference signal received power is higher than a reference signal received power threshold; compare each of the acquired network metrics for the second network to an associated network metric condition; and in the case where the measured reference signal received quality is higher than the reference signal received quality threshold and the measured reference signal received power is higher than the reference signal received power threshold, cause or allow data offloading to be performed from the second network to the first network; or in the case where one or more of the acquired network metrics for the second network meets the associated network metric condition, cause or allow data offloading to be performed from the second network to the first network.

In some embodiments, the apparatus further comprises wherein the network metrics for the second network comprise one or more of channel utilization, backhaul downlink bandwidth, backhaul uplink bandwidth, and received signal strength indicator.

In some embodiments, the apparatus further comprises the at least one memory and the computer program code configured to, with the at least one processor, cause the apparatus at least to: receive the reference signal received power threshold from the first network; receive the reference signal received quality threshold from the first network; and receive one or more network metric thresholds from the first network.

In some embodiments, the apparatus further comprises wherein the second network is a wireless local area network.

In one embodiment, a computer program product is provided comprising at least one non-transitory computer-readable storage medium bearing computer program code portions embodied therein for use with a computer, the computer program code portions comprising program code instructions configured, upon execution, to: cause measurement of a reference signal received power of a serving cell in the first network to be performed; cause measurement of a reference signal received quality of a serving cell in the first network to be performed; cause one or more network metrics for a second network to be acquired; determine whether the measured reference signal received quality is lower than a reference signal received quality threshold; determine whether the measured reference signal received power is lower than a reference signal received power threshold; and in the case where the measured reference signal received quality is lower than the reference signal received quality threshold or the measured reference signal received power is lower than the reference signal received power threshold: determine whether each of the acquired network metrics for the second network meet an associated network metric condition; and if all the associated network metric conditions are met, cause or allow data offloading to be performed from the first network to the second network.

In some embodiments, the computer program product further comprises wherein the network metrics for the second network comprise one or more of: channel utilization, backhaul downlink bandwidth, backhaul uplink bandwidth, and received signal strength indicator.

In some embodiments, the computer program product further comprises program code instructions configured, upon execution, to: receive the reference signal received power threshold from the first network; receive the reference signal received quality threshold from the first network; and receive one or more network metric thresholds from the first network.

In some embodiments, the computer program product further comprises wherein the second network is a wireless local area network.

In one embodiment, a computer program product is provided comprising at least one non-transitory computer-readable storage medium bearing computer program code portions embodied therein for use with a computer, the computer program code portions comprising program code instructions configured, upon execution, to: cause measurement of a reference signal received power of a serving cell in the first network; cause measurement of a reference signal received quality of a serving cell in the first network; cause one or more network metrics for a second network to be acquired; determine whether the measured reference signal received quality is higher than a reference signal received quality threshold; determine whether the measured reference signal received power is higher than a reference signal received power threshold; compare each of the acquired network metrics for the second network to an associated network metric condition; and in the case where the measured reference signal received quality is higher than the reference signal received quality threshold and the measured reference signal received power is higher than the reference signal received power threshold, cause or allow data offloading to be performed from the second network to the first network; or in the case where one or more of the acquired network metrics for the second network meets the associated network metric condition, cause or allow data offloading to be performed from the second network to the first network.

In some embodiments, the computer program product further comprises wherein the network metrics for the second network comprise one or more of channel utilization, backhaul downlink bandwidth, backhaul uplink bandwidth, and received signal strength indicator.

In some embodiments, the computer program product further comprises program code instructions configured, upon execution, to: receive the reference signal received power threshold from the first network; receive the reference signal received quality threshold from the first network; and receive one or more network metric thresholds from the first network.

In some embodiments, the computer program product further comprises wherein the second network is a wireless local area network.

That which is claimed:

1. A method comprising:
causing measurement of a reference signal received power of a serving cell in the first network to be performed;
causing measurement of a reference signal received quality of a serving cell in the first network to be performed;
causing one or more network metrics for a second network to be acquired;
determining, by a processor, whether the measured reference signal received quality is lower than a reference signal received quality threshold;
determining, by a processor, whether the measured reference signal received power is lower than a reference signal received power threshold; and
in the case where the measured reference signal received quality is lower than the reference signal received quality threshold:
causing the reference signal received power threshold to be adjusted;
determining, by the processor, whether each of the acquired network metrics for the second network meet an associated network metric condition; and
if all the associated network metric conditions are met, data offloading can be performed from the first network to the second network; and
in the case where the measured reference signal received power is lower than the reference signal received power threshold:
causing the reference signal received quality threshold to be adjusted;
determining, by the processor, whether each of the acquired network metrics for the second network meet an associated network metric condition; and
if all the associated network metric conditions are met, data offloading can be performed from the first network to the second network.

2. The method of claim 1 wherein the network metrics for the second network comprise one or more of: channel utilization, backhaul downlink bandwidth, backhaul uplink bandwidth, and received signal strength indicator.

3. The method of claim 1 further comprising:
receiving the reference signal received power threshold from the first network;
receiving the reference signal received quality threshold from the first network; and
receiving one or more network metric thresholds from the first network.

4. The method of claim 1 wherein the second network is a wireless local area network.

5. The method of claim 1 wherein causing the reference signal received power threshold to be adjusted comprises one of ignoring the reference signal received power threshold or changing the reference signal received power threshold and causing the reference signal received quality threshold to be adjusted comprises one of ignoring the reference signal received quality threshold or changing the reference signal received quality threshold.

6. A method comprising:
causing measurement of a reference signal received power of a serving cell in the first network;
causing measurement of a reference signal received quality of a serving cell in the first network;
causing one or more network metrics for a second network to be acquired;
determining, by a processor, whether the measured reference signal received quality is higher than a reference signal received quality threshold;
determining, by the processor, whether the measured reference signal received power is higher than a reference signal received power threshold;
comparing each of the acquired network metrics for the second network to an associated network metric condition; and
in the case where the measured reference signal received quality is higher than the reference signal received quality threshold and the measured reference signal received power is higher than the reference signal received power threshold, data offloading can be performed from the second network to the first network; or
in the case where one or more of the acquired network metrics for the second network meets the associated network metric condition, causing data offloading to be performed from the second network to the first network.

7. The method of claim 6 wherein the network metrics for the second network comprise one or more of channel utilization, backhaul downlink bandwidth, backhaul uplink bandwidth, and received signal strength indicator.

8. The method of claim 6 further comprising:
receiving the reference signal received power threshold from the first network;
receiving the reference signal received quality threshold from the first network; and
receiving one or more network metric thresholds from the first network.

9. The method of claim 6 wherein the second network is a wireless local area network.

10. An apparatus comprising at least one processor and at least one memory including computer program code, the at least one memory and the computer program code configured to, with the at least one processor, cause the apparatus at least to:
cause measurement of a reference signal received power of a serving cell in the first network to be performed;
cause measurement of a reference signal received quality of a serving cell in the first network to be performed;
cause one or more network metrics for a second network to be acquired;
determine whether the measured reference signal received quality is lower than a reference signal received quality threshold;
determine whether the measured reference signal received power is lower than a reference signal received power threshold; and
in the case where the measured reference signal received quality is lower than the reference signal received quality threshold:
cause the reference signal received power threshold to be adjusted;
determine whether each of the acquired network metrics for the second network meet an associated network metric condition; and
if all the associated network metric conditions are met, data offloading can be performed from the first network to the second network; and
in the case where the measured reference signal received power is lower than the reference signal received power threshold:
cause the reference signal received quality threshold to be adjusted;
determine whether each of the acquired network metrics for the second network meet an associated network metric condition; and
if all the associated network metric conditions are met, data offloading can be performed from the first network to the second network.

11. The apparatus of claim 10 wherein the network metrics for the second network comprise one or more of: channel utilization, backhaul downlink bandwidth, backhaul uplink bandwidth, and received signal strength indicator.

12. The apparatus of claim 10 further comprising the at least one memory and the computer program code configured to, with the at least one processor, cause the apparatus at least to:
receive the reference signal received power threshold from the first network;
receive the reference signal received quality threshold from the first network; and
receive one or more network metric thresholds from the first network.

13. The apparatus of claim 10 wherein causing the reference signal received power threshold to be adjusted comprises one of ignoring the reference signal received power threshold or changing the reference signal received power threshold and causing the reference signal received quality threshold to be adjusted comprises one of ignoring the reference signal received quality threshold or changing the reference signal received quality threshold.

14. The apparatus of claim 10 wherein the second network is a wireless local area network.

15. An apparatus comprising at least one processor and at least one memory including computer program code, the at least one memory and the computer program code configured to, with the at least one processor, cause the apparatus at least to:
cause measurement of a reference signal received power of a serving cell in the first network;
cause measurement of a reference signal received quality of a serving cell in the first network;
cause one or more network metrics for a second network to be acquired;
determine whether the measured reference signal received quality is higher than a reference signal received quality threshold;
determine whether the measured reference signal received power is higher than a reference signal received power threshold;
compare each of the acquired network metrics for the second network to an associated network metric condition; and
in the case where the measured reference signal received quality is higher than the reference signal received quality threshold and the measured reference signal received power is higher than the reference signal received power threshold, data offloading can be performed from the second network to the first network; or
in the case where one or more of the acquired network metrics for the second network meets the associated network metric condition, data offloading can be performed from the second network to the first network.

16. The apparatus of claim 15 wherein the network metrics for the second network comprise one or more of channel utilization, backhaul downlink bandwidth, backhaul uplink bandwidth, and received signal strength indicator.

17. The apparatus of claim 15 further comprising the at least one memory and the computer program code configured to, with the at least one processor, cause the apparatus at least to:
receive the reference signal received power threshold from the first network;
receive the reference signal received quality threshold from the first network; and
receive one or more network metric thresholds from the first network.

18. The apparatus of claim 15 wherein the second network is a wireless local area network.

19. A computer program product comprising at least one non-transitory computer-readable storage medium bearing computer program code portions embodied therein for use with a computer, the computer program code portions comprising program code instructions configured, upon execution, to:
cause measurement of a reference signal received power of a serving cell in the first network to be performed;
cause measurement of a reference signal received quality of a serving cell in the first network to be performed;
cause one or more network metrics for a second network to be acquired;
determine whether the measured reference signal received quality is lower than a reference signal received quality threshold;
determine whether the measured reference signal received power is lower than a reference signal received power threshold; and
in the case where the measured reference signal received quality is lower than the reference signal received quality threshold:
cause the reference signal received power threshold to be adjusted;
determine whether each of the acquired network metrics for the second network meet an associated network metric condition; and
if all the associated network metric conditions are met, data offloading can be performed from the first network to the second network; and
in the case where the measured reference signal received power is lower than the reference signal received power threshold:
cause the reference signal received quality threshold to be adjusted;
determine whether each of the acquired network metrics for the second network meet an associated network metric condition; and
if all the associated network metric conditions are met, data offloading can be performed from the first network to the second network.

20. The computer program product of claim 19 wherein the network metrics for the second network comprise one or more of: channel utilization, backhaul downlink bandwidth, backhaul uplink bandwidth, and received signal strength indicator.

21. The computer program product of claim 19 further comprising program code instructions configured, upon execution, to:
receive the reference signal received power threshold from the first network;
receive the reference signal received quality threshold from the first network; and
receive one or more network metric thresholds from the first network.

22. The computer program product of claim 19 wherein causing the reference signal received power threshold to be adjusted comprises one of ignoring the reference signal received power threshold or changing the reference signal received power threshold and causing the reference signal received quality threshold to be adjusted comprises one of ignoring the reference signal received quality threshold or changing the reference signal received quality threshold.

23. The computer program product of claim 19 wherein the second network is a wireless local area network.

24. A computer program product comprising at least one non-transitory computer-readable storage medium bearing computer program code portions embodied therein for use with a computer, the computer program code portions comprising program code instructions configured, upon execution, to:
cause measurement of a reference signal received power of a serving cell in the first network;
cause measurement of a reference signal received quality of a serving cell in the first network;
cause one or more network metrics for a second network to be acquired;
determine whether the measured reference signal received quality is higher than a reference signal received quality threshold;
determine whether the measured reference signal received power is higher than a reference signal received power threshold;
compare each of the acquired network metrics for the second network to an associated network metric condition; and
in the case where the measured reference signal received quality is higher than the reference signal received quality threshold and the measured reference signal received power is higher than the reference signal received power threshold, cause data offloading to be performed from the second network to the first network; or
in the case where one or more of the acquired network metrics for the second network meets the associated network metric condition, cause data offloading to be performed from the second network to the first network.

25. The computer program product of claim 24 wherein the network metrics for the second network comprise one or more of channel utilization, backhaul downlink bandwidth, backhaul uplink bandwidth, and received signal strength indicator.

26. The computer program product of claim 24 further comprising program code instructions configured, upon execution, to:
receive the reference signal received power threshold from the first network;
receive the reference signal received quality threshold from the first network; and
receive one or more network metric thresholds from the first network.

27. The computer program product of claim 24 wherein the second network is a wireless local area network.
